(19) United States
(12) Patent Application Publication
(10) Pub. No.: US 2024/0243791 A1
(43) Pub. Date: Jul. 18, 2024

(54) TECHNIQUES FOR BEAM WIDTH ADJUSTMENT IN BEAMFORMING COMMUNICATIONS

(71) Applicant: QUALCOMM INCORPORATED, San Diego, CA (US)

(72) Inventors: Min Huang, Beijing (CN); Wei Xi, Beijing (CN); Chao Wei, Beijing (CN); Hao Xu, Beijing (CN)

(21) Appl. No.: 18/563,227

(22) PCT Filed: Jul. 16, 2021
(86) PCT No.: PCT/CN2021/106667

§ 371 Date: Nov. 21, 2023

(51) Int. Cl. H04B 7/06; H04B 7/0413

(52) U.S. Cl. CPC H04B 7/0617; H04B 7/0413

(57) ABSTRACT

Methods, systems, and devices for wireless communications are described. A user equipment (UE) located in a near field of a base station may receive a beamformed signal from the base station via a three-dimensional (3D) transmission beam. The UE may receive the signal at an antenna panel and detect a signal strength distribution of the signal at the antenna panel. The UE may calculate a signal weight for each portion of the antenna panel and determine beam adjustment information based on the signal weights. The UE may report the beam adjustment information to the base station, and the base station may use the beam adjustment information to adjust the beamwidth of the 3D transmission beam for subsequent transmissions to the UE, which may increase a beamforming gain at the antenna, and improve communication data rate.

### CROSS REFERENCE

The present application is a 371 national stage filing of International PCT Application No. PCT/CN2021/106667 by Huang et al. entitled “TECHNIQUES FOR BEAM WIDTH ADJUSTMENT IN BEAMFORMING COMMUNICATIONS,” filed Jul. 16, 2021, which is assigned to the assignee hereof, and which is expressly incorporated by reference in its entirety herein.

### FIELD OF TECHNOLOGY

The following relates to wireless communications, including techniques for beam width adjustment in beamforming communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a base station may communicate with one or more UEs using beamforming techniques. But in some situations, existing beamforming techniques may be deficient.

### SUMMARY

The described techniques relate to improved methods, systems, devices, and apparatuses that support techniques for beam width adjustment in beamforming communications. Generally, the described techniques provide for enabling a user equipment (UE) located in a near field of a base station to provide the base station with beam adjustment information to improve holographic multiple-input multiple-output (MIMO) communications. For example, the base station may transmit a beamformed signal to the UE via a three-dimensional (3D) transmission beam. The UE may receive the signal at an antenna panel and detect a signal strength distribution of the signal at the antenna panel. The UE may calculate a signal weight for each portion of the antenna panel and determine beam adjustment information based on the signal weights. The UE may report the beam adjustment information to the base station, and the base station may use the beam adjustment information to adjust the beamwidth of the 3D transmission beam for subsequent transmissions to the UE, which may increase a beamforming gain at the antenna, and improve communication data rate.

A method for wireless communications at a UE is described. The method may include receiving, from a base station, a beamformed signal via a beam within a distance threshold for MIMO communications from the base station and transmitting, to the base station, a report indicating a beam adjustment parameter based on a signal distribution of the beamformed signal at an antenna panel of the UE.

An apparatus for wireless communications at a UE is described. The apparatus may include a processor, memory coupled with the processor, and instructions stored in the memory. The instructions may be executable by the processor to cause the apparatus to receive, from a base station, a beamformed signal via a beam within a distance threshold for MIMO communications from the base station and transmit, to the base station, a report indicating a beam adjustment parameter based on a signal distribution of the beamformed signal at an antenna panel of the UE.

Another apparatus for wireless communications at a UE is described. The apparatus may include means for receiving, from a base station, a beamformed signal via a beam within a distance threshold for MIMO communications from the base station and means for transmitting, to the base station, a report indicating a beam adjustment parameter based on a signal distribution of the beamformed signal at an antenna panel of the UE.

A non-transitory computer-readable medium storing code for wireless communications at a UE is described. The code may include instructions executable by a processor to receive, from a base station, a beamformed signal via a beam within a distance threshold for MIMO communications from the base station and transmit, to the base station, a report indicating a beam adjustment parameter based on a signal distribution of the beamformed signal at an antenna panel of the UE.

Some examples of the method, apparatuses, and non-transitory computer-readable medium described herein may further include operations, features, means, or instructions for calculating a set of channel response values, each channel response value associated with a respective element of a set of elements at the antenna panel, where the beam adjustment parameter may be based on the set of channel response values.

Some examples of the method, apparatuses, and non-transitory computer-readable medium described herein may further include operations, features, means, or instructions for determining a beam width of the beam based on a set of received signal strength values, each received signal strength value associated with a respective element of a set of elements at the antenna panel, where the beam adjustment parameter may be based on a ratio associated with the determined beam width and a target beam width.

Some examples of the method, apparatuses, and non-transitory computer-readable medium described herein may further include operations, features, means, or instructions for determining a signal strength variance based on a set of received signal strength values, each received signal strength value associated with a respective element of a set of elements at the antenna panel, where the beam adjustment parameter may be based on the signal strength variance.

Some examples of the method, apparatuses, and non-transitory computer-readable medium described herein may further include operations, features, means, or instructions for receiving, from the base station, a second beamformed signal via a second beam within the near field of the MIMO communications, the second beam based on the beam adjustment parameter in the transmitted report.

In some examples of the method, apparatuses, and non-transitory computer-readable medium described herein, a beam width of the second beam may be based on a value of the beam adjustment parameter.

Some examples of the method, apparatuses, and non-transitory computer-readable medium described herein may further include operations, features, means, or instructions for receiving, from the base station, an indication that the UE may be located within the distance threshold for MIMO communications from the base station, where receiving the beamformed signal may be based on receiving the indication.

In some examples of the method, apparatuses, and non-transitory computer-readable medium described herein, the report may be transmitted in a radio resource control (RRC) message, a medium access control (MAC) control element (CE), a physical layer message, a channel state information (CSI) message, or any combination thereof.

In some examples of the method, apparatuses, and non-transitory computer-readable medium described herein, the beamformed signal includes a data signal, a reference signal, or both.

In some examples of the method, apparatuses, and non-transitory computer-readable medium described herein, the distance threshold may be based on a size of an antenna panel at the base station, a wavelength associated with the beam, or both.

A method for wireless communications at a base station is described. The method may include transmitting, to a UE, a beamformed signal via a beam within a distance threshold for MIMO communications from the base station and receiving, from the UE, a report indicating a beam adjustment parameter based on a signal distribution of the beamformed signal at an antenna panel of the UE.

An apparatus for wireless communications at a base station is described. The apparatus may include a processor, memory coupled with the processor, and instructions stored in the memory. The instructions may be executable by the processor to cause the apparatus to transmit, to a UE, a beamformed signal via a beam within a distance threshold for MIMO communications from the base station and receive, from the UE, a report indicating a beam adjustment parameter based on a signal distribution of the beamformed signal at an antenna panel of the UE.

Another apparatus for wireless communications at a base station is described. The apparatus may include means for transmitting, to a UE, a beamformed signal via a beam within a distance threshold for MIMO communications from the base station and means for receiving, from the UE, a report indicating a beam adjustment parameter based on a signal distribution of the beamformed signal at an antenna panel of the UE.

A non-transitory computer-readable medium storing code for wireless communications at a base station is described. The code may include instructions executable by a processor to transmit, to a UE, a beamformed signal via a beam within a distance threshold for MIMO communications from the base station and receive, from the UE, a report indicating a beam adjustment parameter based on a signal distribution of the beamformed signal at an antenna panel of the UE.

Some examples of the method, apparatuses, and non-transitory computer-readable medium described herein may further include operations, features, means, or instructions for generating a second beam based on the beam adjustment parameter in the received report and transmitting, to the UE, a second beamformed signal via the second beam within the near field of the MIMO communications.

In some examples of the method, apparatuses, and non-transitory computer-readable medium described herein, a beam weight, a target distance, a beam width, or any combination thereof, of the generated second beam may be based on a value of the beam adjustment parameter.

In some examples of the method, apparatuses, and non-transitory computer-readable medium described herein, the beam may be generated at a first antenna panel at the base station and the second beam may be generated at a second antenna panel at the base station different from the first antenna panel.

In some examples of the method, apparatuses, and non-transitory computer-readable medium described herein, the beam may be generated using a first beamforming weight vector and the second beam may be generated using a second beamforming weight vector different from the first beamforming weight vector.

In some examples of the method, apparatuses, and non-transitory computer-readable medium described herein, the beam adjustment parameter includes a set of channel response values.

In some examples of the method, apparatuses, and non-transitory computer-readable medium described herein, the beam adjustment parameter includes a beam width ratio value.

In some examples of the method, apparatuses, and non-transitory computer-readable medium described herein, the beam adjustment parameter includes a signal strength variance value.

Some examples of the method, apparatuses, and non-transitory computer-readable medium described herein may further include operations, features, means, or instructions for transmitting, to the UE, an indication that the UE may be located within the distance threshold for MIMO communications from the base station, where transmitting the beamformed signal may be based on transmitting the indication.

In some examples of the method, apparatuses, and non-transitory computer-readable medium described herein, the report may be received in a RRC message, a MAC CE, a physical layer message, a CSI message, or any combination thereof.

In some examples of the method, apparatuses, and non-transitory computer-readable medium described herein, the beamformed signal includes a data signal, a reference signal, or both.

In some examples of the method, apparatuses, and non-transitory computer-readable medium described herein, the distance threshold may be based on a size of an antenna panel at the base station, a wavelength associated with the beam, or both.

### BRIEF DESCRIPTION OF THE DRAWINGS

FIG. 1 illustrates an example of a wireless communications system that supports techniques for beam width adjustment in beamforming communications in accordance with aspects of the present disclosure.

FIG. 2 illustrates an example of a wireless communications system that supports techniques for beam width adjustment in beamforming communications in accordance with aspects of the present disclosure.

FIG. 3 illustrates an example of a wireless communications system that supports techniques for beam width adjustment in beamforming communications in accordance with aspects of the present disclosure.

FIG. 4 illustrates an example of a process flow that supports techniques for beam width adjustment in beamforming communications in accordance with aspects of the present disclosure.

FIGS. 5 and 6 show block diagrams of devices that support techniques for beam width adjustment in beamforming communications in accordance with aspects of the present disclosure.

FIG. 7 shows a block diagram of a communications manager that supports techniques for beam width adjustment in beamforming communications in accordance with aspects of the present disclosure.

FIG. 8 shows a diagram of a system including a device that supports techniques for beam width adjustment in beamforming communications in accordance with aspects of the present disclosure.

FIGS. 9 and 10 show block diagrams of devices that support techniques for beam width adjustment in beamforming communications in accordance with aspects of the present disclosure.

FIG. 11 shows a block diagram of a communications manager that supports techniques for beam width adjustment in beamforming communications in accordance with aspects of the present disclosure.

FIG. 12 shows a diagram of a system including a device that supports techniques for beam width adjustment in beamforming communications in accordance with aspects of the present disclosure.

FIGS. 13 through 18 show flowcharts illustrating methods that support techniques for beam width adjustment in beamforming communications in accordance with aspects of the present disclosure.

### DETAILED DESCRIPTION

Devices in some wireless communications systems (e.g., fifth generation (5G) systems which may be referred to as New Radio (NR) systems, or sixth generation (6G) systems) may communicate using beamforming techniques, which may also be referred to as spatial filtering, directional transmission, or directional reception. For example, a UE may communicate with a base station using beamformed transmissions in a millimeter wave (mmW) frequency spectrum. The UE or the base station may combine signals communicated via a set of antennas such that signals propagating in a first orientation with respect to the set of antennas may experience constructive interference, and signals propagating in other orientations may experience destructive interference. Such beamforming techniques may be referred to as two-dimensional (2D) beamforming

In some cases, a UE or a base station may use multiple-input multiple-output (MIMO) communications to transmit or receive multiple signals via different spatial layers. The multiple signals may, for example, be transmitted or received via different antennas or different combinations of antennas. However, in some scenarios (e.g., when a base station performing multiple-user MIMO (MU-MIMO) communications), 2D beamforming techniques may be deficient. For example, two UEs may be positioned at different distances from a base station and may be positioned collinear with a transmission beam from the base station. That is, the two UEs may have a same angular orientation with respect to the base station. In such an example, the base station may be unable to multiplex transmissions to the two UEs using 2D beamforming techniques. That is, the base station may not be able to perform MU-MIMO communications with UEs that have a same angular orientation. Additionally, beams formed using 2D beamforming techniques may cover a wide angle compared to a reception point (e.g., a UE) of the beams, which may lead to an inefficient use of communication resources.

In some cases, devices may use three-dimension (3D) beamforming techniques to perform holographic MIMO (H-MIMO) communications. For example, a base station may communicate with one or more UEs located in a near field of the base station (e.g., in a region proximal to or within a threshold distance of the base station. The base station may use 3D beamforming techniques to communicate with UEs in the near field, where the base station may form a transmission beam capable of distinguishing between UEs based on both angular orientation and distance from the base station. However, in some cases, a refining process for generating 3D beamformed transmission beams may result in relatively unequal signal strengths at an antenna panel of a UE, for example due to relatively small beamwidths of the 3D beams.

According to the techniques described herein, a UE located in a near field of a base station configured to use 3D beamforming techniques may provide the base station with beam adjustment information to improve H-MIMO communications. For example, the base station may transmit a beamformed signal to the UE via a 3D transmission beam. The UE may receive the signal at an antenna panel (e.g., a set of antenna elements or an antenna array) and detect a signal strength distribution of the signal at the antenna panel. The signal strength distribution may be representative of a beamwidth of the transmission beam at the antenna panel. For example, the UE may detect the signal at each portion of the antenna panel (e.g., an antenna element, or a partition of the antenna panel). The UE may calculate a signal weight for each portion and determine beam adjustment information based on the signal weights. For example, the beam adjustment information may include a ratio of a target beam width and a current beam width, a variance of the signal strengths at the antenna panel, or both. The UE may report the beam adjustment information to the base station, and the base station may use the beam adjustment information to adjust the beamwidth of the 3D transmission beam for subsequent transmissions to the UE. For example, the base station may transmit signaling targeting a distance closer to the UE, further from the UE, using a different size transmit panel, using a different size beamwidth, or any combination thereof, to provide the UE with a more uniform signal strength distribution at the antenna panel, which may increase a beamforming gain at the antenna, and improve communication data rate.

Aspects of the disclosure are initially described in the context of wireless communications systems. Aspects of the disclosure are further illustrated by and described with reference to a process flow, apparatus diagrams, system diagrams, and flowcharts that relate to techniques for beam width adjustment in beamforming communications.

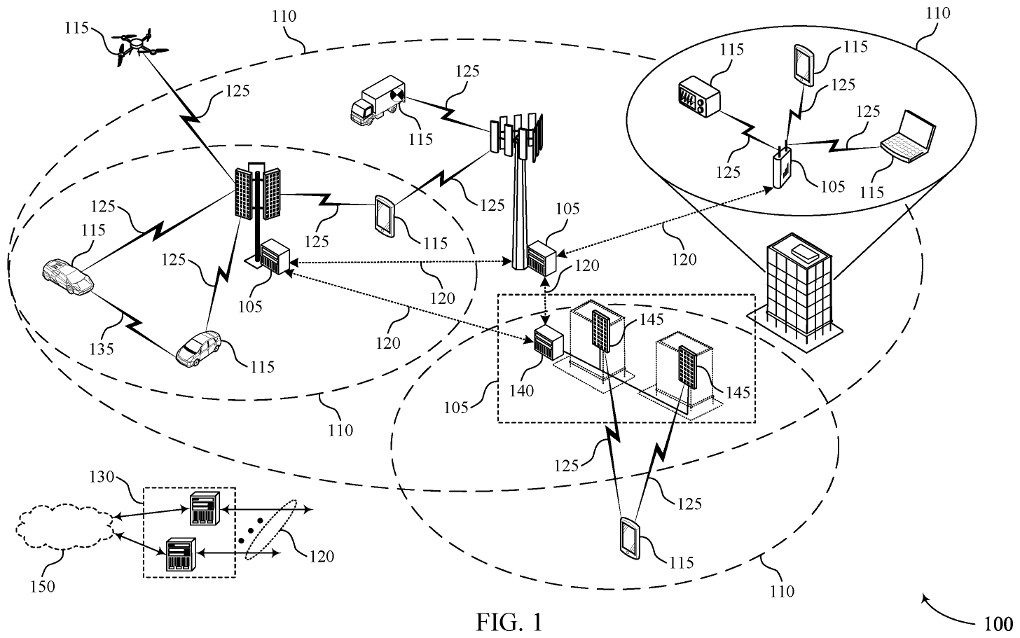

FIG. 1 illustrates an example of a wireless communications system 100 that supports techniques for beam width adjustment in beamforming communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

ρhysical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communications system 100 may also operate in a super high frequency (SHF) region using frequency bands from 3 GHZ to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

According to the techniques described herein, a UE 115 located in a near field of a base station 105 configured to use 3D beamforming techniques may provide the base station 105 with beam adjustment information to improve H-MIMO communications. For example, the base station 105 may transmit a beamformed signal to the UE 115 via a 3D transmission beam. The UE 115 may receive the signal at an antenna panel (e.g., a set of antenna elements or an antenna array) and detect a signal strength distribution of the signal at the antenna panel. The signal strength distribution may be representative of a beamwidth of the transmission beam at the antenna panel. For example, the UE 115 may detect the signal at each portion of the antenna panel (e.g., an antenna element, or a partition of the antenna panel). The UE 115 may calculate a signal weight for each portion and determine beam adjustment information based on the signal weights. For example, the beam adjustment information may include a ratio of a target beam width and a current beam width, a variance of the signal strengths at the antenna panel, or both. The UE 115 may report the beam adjustment information to the base station 105, and the base station 105 may use the beam adjustment information to adjust the beamwidth of the 3D transmission beam for subsequent transmissions to the UE 115, which may increase a beamforming gain at the antenna, and improve communication data rate.

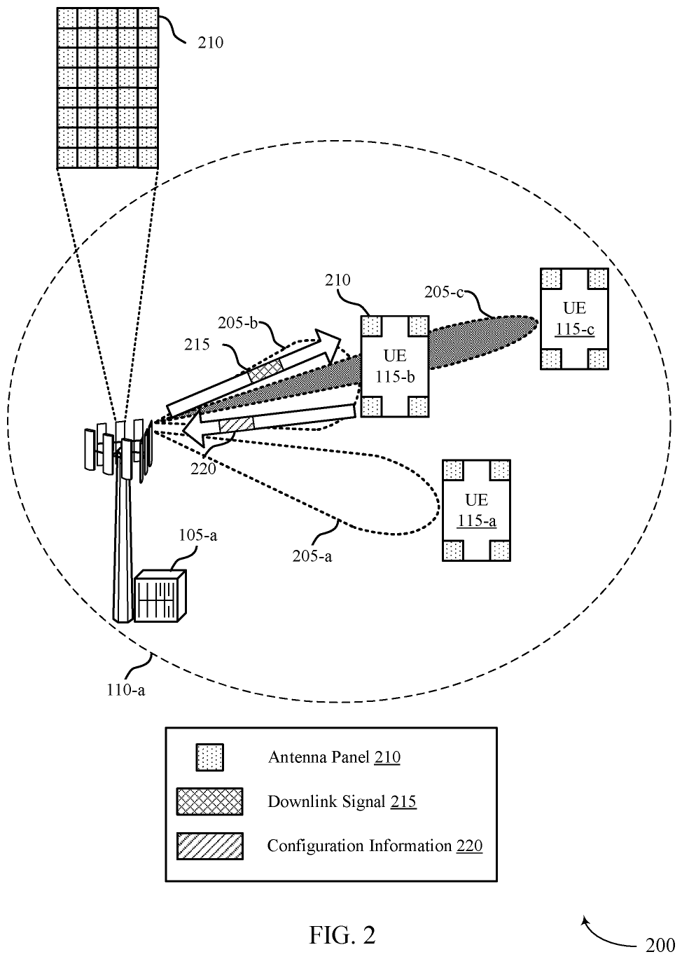

FIG. 2 illustrates an example of a wireless communications system 200 that supports techniques for beam width adjustment in beamforming communications in accordance with aspects of the present disclosure. In some examples, wireless communications system 200 may implement aspects of wireless communications system 100. The wireless communications system 200 may illustrate communications between UEs 115 and a base station 105-a, which may be examples of corresponding devices as described with reference to FIG. 1. In some examples, the wireless communications system 200 (which may be an example of a 6G system, a 5G or NR system, or another system for wireless communications) may support H-MIMO communications, where the base station 105-a may be configured to multiplex beamformed transmissions to one or more UEs 115 within a near field of the base station 105-a. In some examples, the near field of the base station 105-a may include a coverage area 110-a.

Devices in the wireless communications system 200 may be configured to transmit and receive signaling using one or more antenna panels 210. Devices equipped with one or more antenna panels 210 may be operable to use any number of antenna panels 210 to transmit or receive signaling. For example, in the wireless communications system 200, the base station 105-a may include a relative large quantity of antenna panels 210 to enable MU-MIMO communications. The base station 105-a may be configured to use any number of antenna panels 210 to transmit signaling to the UEs 115. In some cases, transmitting signaling using a specific configuration of antenna panels 210 may result in regions of constructive interference and regions of destructive interference, for example, forming one or more transmission beams 205.

In some examples, the devices in the wireless communications system 200 may be configured to communicate using one or more beams 205 formed using 2D beamforming techniques. For example, the base station 105-a may concentrate transmission power in the direction of a UE 115-a, forming a beam 205-a that the base station 105-a may use to communicate with the UE 115-a. The base station 105-a may focus the beam 205-a using parameters based on angles in azimuth and zenith (e.g., azimuth angle of departure (AoD), azimuth angle of arrival (AoA), zenith angle of departure (ZoD), zenith angle of arrival (ZoD)). As illustrated in FIG. 2, the base station 105-a may additionally form a beam 205-b to communicate with a UE 115-b such that the base station 105-a may multiplex the UE 115-a and the UE 115-b for MU-MIMO communications. That is, the base station 105-a may form multiple beams 205 for communicating with or otherwise providing service for respective UEs 115.

In some cases, 2D beamforming techniques may be deficient, for example due to limited UE 115 discrimination, or low transmission power efficiency, among other examples. For example, the base station 105-a may not be able to distinguish between UEs 115 based on distance from the base station 105-a. As illustrated in FIG. 2, the UE 115-b and a UE 115-c may be positioned collinear with the beam 205-b such that the base station 105-a may be unable to discriminate between the UE 115-b and the UE 115-c using 2D beamforming techniques. That is, the base station 105-a may not support distance discrimination using a 2D beamformed communication beam 205, which may limit MIMO support for UEs 115 positioned at a substantially equivalent orientation (e.g., based on an angle of azimuth and an angle of zenith) with respect to the base station 105-a. In such an example, the base station may 105-a be limited with respect to MU-MIMO pairing opportunities (e.g., between the UE 115-b and the UE 115-c) or MU-MIMO diversity gain, or the base station 105-a may experience reduced cell-level spectral efficiency. In some cases, the base station 105-a may transmit signals with a beam 205 associated with a relatively low transmission power efficiency (e.g., as compared to a beam 205 beamformed with a small beam width granularity). For example, the base station 105-a may communicate with the UE 115-a using the beam 205-a, where the beam 205-a may span a relatively large area as compared to the size (e.g., a physical area) of UE 115-a. That is, the base station 105-a may transmit signals using the beam 205-a, spreading the transmission power for the signals across the entirety of the beam 205-a. As such, using the beam 205-a, the base station 105-a may transmit signals to locations other than the location of UE 115-a, which may lead to inefficient use of communication resources.

In some examples, the devices in the wireless communications system 200 may be configured to communicate using one or more beams 205 formed using 3D beamforming techniques. For coverage distances (e.g., distances between the base station 105-a and UE 115-c) within the near field of the base station 105-a, where coverage distances are short compared to a size of an antenna panel 210 of the base station 105-a, generated beams 205 may have holographic characteristics. Such holographic characteristics may enable discrimination between UEs 115 based on both direction and distance. In other words, the base station 105-a may generate the beam 205-c with a specific angular range and a specific distance range, for example corresponding to a location and size of the UE 115-c, thereby focusing transmission power at the location of the UE 115-c.

In some cases, the base station 105-a may be configured to perform H-MIMO communications, where the base station 105-a may multiplex multiple data streams for UEs 115 otherwise unsupported for MU-MIMO (e.g., using 2D beamforming techniques). For example, as illustrated in FIG. 2, the UE 115-b and the UE 115-c may be positioned at different distances from the base station 105-a, but may be oriented collinear with the beam 205-b (e.g., or the beam 205-c). In such an example, using 3D beamforming techniques, the base station 105-a may be configured to discriminate between the UE 115-b and the UE 115-c such that the base station 105-a may maintain a communications link with the UE 115-b using the beam 205-b and the base station 105-a may maintain a communications link with the UE 115-c using the beam 205-c. As 3D beamforming may enable the base station 105-a to distinguish between UEs 115 in the same direction at different distances, the base station 105-a may pair such UEs 115 for MU-MIMO transmissions, resulting in enhanced MU-MIMO pairing opportunities, improved diversity gains, and improved cell-level spectral efficiency. Additionally, as the base station 105-a may form beams 205 with respect to both direction and distance, the base station 105-a may configure a beam 205 to cover a smaller area as compared to the area covered by beams 205 formed using 2D beamforming techniques. For example, the base station 105-a may configure beam 205-c to cover an area surrounding UE 115-c (e.g., as a spot around UE 115-c). As such, the base station 105-a may transmit signals using beam 205-c, focusing the transmission power of the signals to the area surrounding the UE 115-c, resulting in a more efficient utilization of transmission power and communication resources.

In some cases, when communicating with beams 205 formed using 3D beamforming techniques, a UE 115 may experience an unequal signal strength at a UE antenna panel 210. For example, the base station 105-a may generate beam 205-c such that the beam width of the beam 205-c at the location of the UE 115-c may be relatively small as compared to the size (e.g., the area) of an antenna panel 210 at the UE 115-c. In some examples, the closer the UE 115-c may be located to an antenna panel 210 at the base station 105-a, the smaller the beam width may be. For example, the UE 115-c may be located a first distance (e.g., three meters) from a transmit panel at the base station 105-a where the beam width of the beam 205-c may be a first width (e.g., four centimeters). As such, if the UE 115-c moves closer to the transmit panel where the UE 115-c may be located at a second distance, smaller than the first distance, the beam width of the beam 205-c may be a second width, smaller than the first width. In some examples, beam width may be based on carrier frequency of transmissions via a beam 205. For example, the base station 105-a may communicate with the UE 115-c via the beam 205-c using a first carrier frequency (e.g., 30 GHz) and the beam width of the beam 205-c may be the first width. The base station 105-a may increase the carrier frequency from the first carrier frequency to a second carrier frequency (e.g., 100 GHZ) where, in response, the beam width may decrease to a third width (e.g., one centimeter), smaller than the first width. In some cases, the antenna panel 210 at the UE 115-c may be larger than the size of the beam width of the beam 205-c at the location of the UE 115-c and, as such, the UE 115-c may experience an unequal signal strength distribution at the UE antenna panel 210. For example, the UE 115-c may have a receiving antenna panel 210 with dimensions 10 centimeters by 10 centimeters. In such an example, the base station 105-a may include, or may otherwise support the use of, reflective surfaces such that the base station 105-a may relay transmissions using the reflective surfaces, towards the UE 115-c, increasing the area of the receiving antenna panel 210 covered by the beam 205-c. In such examples, the beam width of the beam 205-c may be relatively small, such that the UE 115-c may experience unequal signal strength distribution at the antenna panel 210.

In some cases, unequal signal strength distribution at the antenna panel 210 may result in diminished combining gain. In some examples, a UE 115 may be configured to use analog beamforming techniques, combining signals from different antenna panels to reconstruct a received signal. For example, the UE 115-b may receive a signal from the base station 105-a using an antenna panel 210 where the antenna panel 210 may be partitioned into nine antenna portions. The UE 115-b may receive the signal using each of the nine antenna portions and may combine the receiving results to reconstruct the received signal. In some cases, a channel gain associated with receiving signals may be increased if the UE 115-b receives signals with substantially equal amplitude at each antenna portion (e.g., such that combining coefficients may be constant-modulo). In cases where the UE 115-b receives signals with unequal amplitudes at each antenna portion, the UE 115-b may not be able to perform a maximum ratio combining (MRC), which may reduce an antenna combining gain.

Further, in some cases, using beams 205 with small beam widths may result in diminished beam sweeping performance. For example, the base station 105-a may form beam 205-b with a relatively small beam width at the location of the UE 115-b as compared to a size of an antenna panel 210. In such an example, the small beam width may cause unequal signal distribution at the antenna panel 210 and the UE 115-b may experience weak beamforming gain. As such, the UE 115-b may determine to select a new beam 205, as the UE 115-b may determine that the beam 205-b may be insufficient for communications with the base station 105-a. However, the base station 105-a may generate a new beam 205 (not shown), where the new beam 205 may have a relatively small beam width as compared to the size of the antenna panel 210 at the location of the UE 115-b. As such, the UE 115-b may determine the new beam 205 may be insufficient for communications. As part of a beam sweeping procedure, the base station 105-a may generate such unsatisfactory beams (e.g., having small beam widths) and the UE 115-b may be unable to select a satisfactory beam. In some other cases, beams 205 generated as part of the beam sweeping procedure may have beam widths large enough to cover the antenna panel 210, but may be relatively small such that the number of beams 205 used to sweep an angular range may introduce system latency. For example, beams 205 generated using 3D beamforming techniques may have small beam widths as compared to beams 205 generated using 2D beamforming techniques and, as such, the base station 105-a may generate more 3D beamformed beams 205 to sweep an angular range, resulting in an increase in system latency brought on by beam sweeping.

In some examples, a device located in the near field of the base station 105-a may be configured to indicate beam adjustment information to the base station 105-a such that the base station 105-a may adjust a beam width at the location of the device. For example, the base station 105-a may transmit a downlink signal 215 to the UE 115-b via the beam 205-b (e.g., formed using 3D beamforming techniques), where the UE 115-b may receive the downlink signal 215 at an antenna panel 210 and may detect the signal strength distribution at the antenna panel 210. In some cases, the signal strength distribution may be representative of a beam width of the beam 205-b at the antenna panel 210. To detect the signal strength distribution, the UE 115-b may detect the signal at each portion of the antenna panel 210 and the UE 115-b may calculate a respective signal weight for each antenna portion. In some examples, the UE 115-b may determine beam adjustment information using the signal weights. For example, the UE 115-b may determine the beam adjustment information to be a ratio of a target beam width to a current beam width (e.g., calculated using the signal weights), a variance of the signal strengths at the antenna panel 210, or both. The UE 115-b may transmit a report 220, including the beam adjustment information, to the base station 105-a and the base station 105-a may use the beam adjustment information to adjust the beam width of the beam 205-b. For example, the base station 105-a may transmit subsequent signaling targeting a distance closer to the UE 115-b, further from the UE 115-b, using a different size transmission antenna panel 210, or any other method for adjusting a beam width, such that the beam width of the beam 205-b at the location of the UE 115-b may correspond to the size of the receiving antenna panel 210. Adjusting the beam width of a beam 205 to more closely match the size of a receiving antenna panel 210 may result in a more uniform signal strength distribution at the receiving antenna panel 210, increased beamforming gain, boosted communication data rates, among other examples.

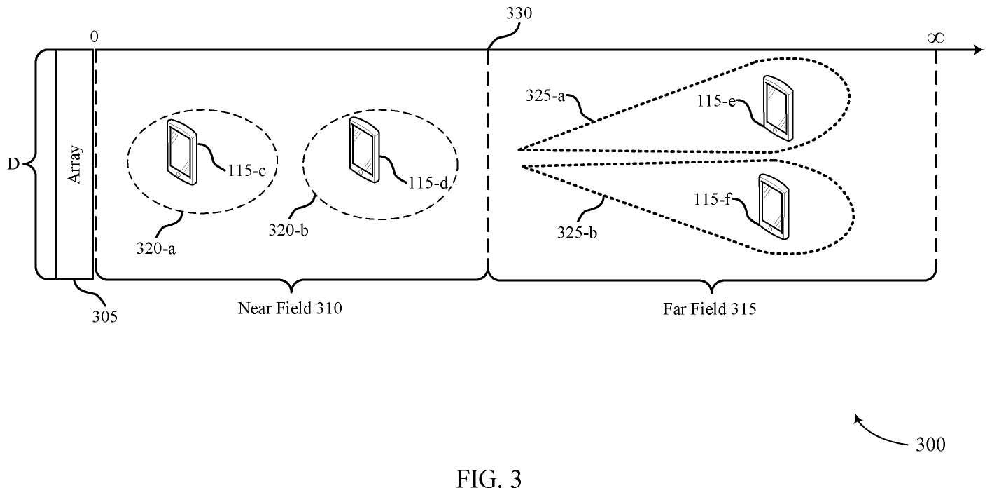

FIG. 3 illustrates an example of a wireless communications system 300 that supports techniques for beam width adjustment in beamforming communications in accordance with aspects of the present disclosure. In some examples, the wireless communications system 300 may implement or be implemented by aspects of the wireless communications systems 100 or 200. For example, the wireless communications system 300 may include UEs 115, which may be examples of corresponding devices described with reference to FIGS. 1 and 2.

A base station (e.g., with an antenna array 305) may be configured to use 3D beamforming techniques to perform H-MIMO communications, where the base station may form transmission beams for communicating with UEs 115 that may distinguish between the UEs 115 and the base station based on both direction and distance. The coverage area close to the antenna array 305 may be called a near field 310, while the coverage area further from the antenna array 305 may be called a far field 315. In some cases, a partitioning distance 330 of the near field 310 (e.g., which may be further divided as a reactive near field and a radiating near field) and the far field 315 may be based on a panel size D of the array 305 and a signal wavelength λ. In some cases, the near field 310 may cover a distance from 0 m to 2D²/λ (e.g., corresponding to the partitioning distance 330) with respect to the antenna array 305, and the far field 315 may cover a distance greater than 2D²/λ (e.g., to a distance of ∞) with respect to the antenna array 305. The near field 310 may include UEs 115-c and 115-d, which may each be served by a 3D beam 320. For example, the UE 115-c may be associated with a 3D beam 320-a, and the UE 115-d may be associated with a 3D beam 320-b. The UEs 115 in the near field 310 may communicate with a base station using H-MIMO beamforming techniques. The far field 315 may include different UEs 115, which may each be served by a 2D beam 325 pointing to each UE 115. For example, a UE 115-e may be associated with a 2D beam 325-a and a UE 115-f may be associated with a 2D beam 325-b. The UEs 115 in the far field 315 may communicate with the base station using NR MIMO beamforming techniques. As the near field 310 and the far field 315 depend on wavelength, the area of the near field 310 may become larger with higher frequency bands.

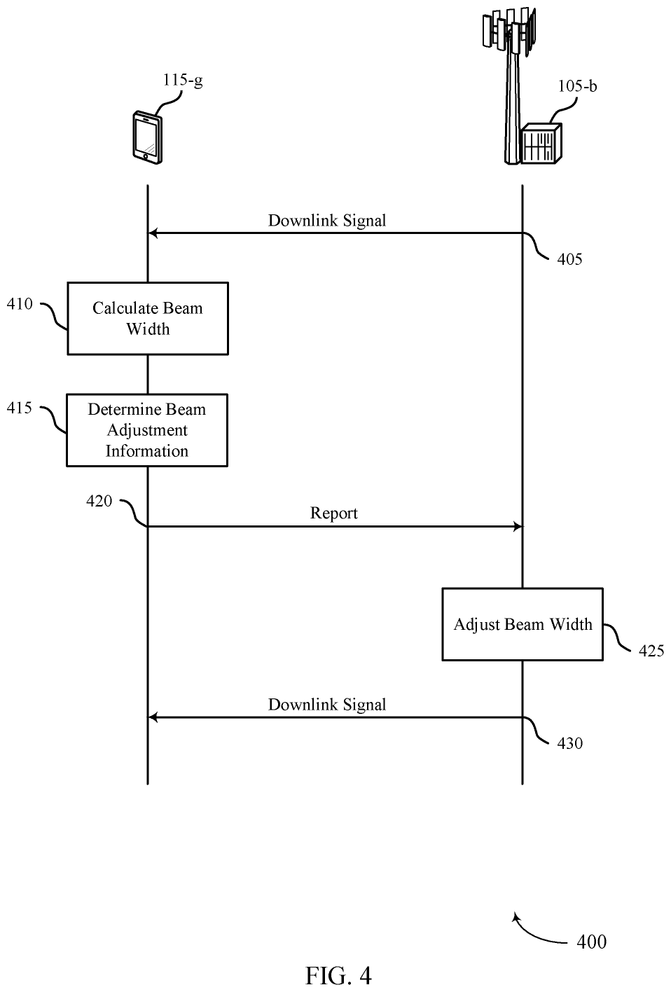

UEs 115 in the far field may receive signals with relatively equal signal strength distributions at receiving antenna panels. For example, the UE 115-e may receive signals from the base station using a receiving antenna panel, where due to the relatively large beam width (e.g., as compared to the size of the receiving antenna panel) of the 2D beam 325-a at the location of the UE 115-e, the UE 115-e may experience a substantially equivalent signal strength distribution across the receiving antenna panel, or antenna portions of the receiving antenna panel. UEs 115 in the near field may receive signals with relatively unequal signal strength distributions as described in more detail with reference to FIG. 2. Configuring UEs 115 to signal beam adjustment information to the base station may support beam width adjustment such that the base station may adjust 3D beams 320 in accordance with, or otherwise based on, the beam adjustment information from the UEs 115. Calculation and signaling of such beam adjustment information is described in more detail with reference to FIG. 4.

FIG. 4 illustrates an example of a process flow 400 that supports techniques for beam width adjustment in beamforming communications in accordance with aspects of the present disclosure. The process flow 400 may implement or be implemented by aspects of wireless communications systems 100, 200, or 300. For example, the process flow 400 may illustrate operations between a UE 115-g and a base station 105-b, which may be examples of corresponding devices described with reference to FIGS. 1 through 3. In the following description of the process flow 400, the operations between the UE 115-g and the base station 105-b may be transmitted in a different order than the example order shown, or the operations performed by the UE 115-g and the base station 105-b may be performed in different orders or at different times. Some operations may also be omitted from the process flow 400, and other operations may be added to the process flow 400.

At 405, the base station 105-b may transmit a downlink signal (e.g., a data signal or a reference signal) to the UE 115-g, where the UE 115-g may receive the downlink signal with a relatively unequal signal strength distribution at a receiving antenna panel. For example, the base station 105-b may transmit the downlink signal using a beam formed using H-MIMO techniques where, at the location of the UE 115-g, the beam used to transmit the downlink signal may have a relatively small beam width (e.g., as compared to the size of the receiving antenna panel).

At 410, the UE 115-g may calculate a beam width using measurement information from the receiving antenna panel associated with receiving the downlink signal at 405. In some examples, the UE 115-g may receive the downlink signal at 405 using partitions of a receiving antenna panel. The UE 115-g may use one or more antennas or antenna portions of the antenna panel and the UE 115-g may determine the signal strength at each antenna or antenna portion. In some examples, the UE may receive the downlink signal at each antenna or antenna portion using one or more flip-over combining weights (e.g., received signal weights), corresponding to respective antennas or antenna portions. As an illustrative example, the UE 115-g may receive the downlink signal at 405 with one or more antennas or antenna portions using the flip-over combining weights illustrated by Equation 1:

$${w}_{0} = [ 1 , 1 , 1 , … , 1 ] , {w}_{1} = [ 1 , - 1 , - 1 , … , - 1 ] , \text{} … , \text{} {w}_{N} = [ - 1 , - 1 , - 1 , … , 1 ] \qquad ( 1 )$$

In Equation 1, w_{N} may be a flip-over combining weight associated with a respective antenna or antenna portion with index N. That is, the UE 115-g may include N antennas or antenna portions, where each flip-over combining weight may correspond to a respective antenna or antenna portion. In some cases, each flip-over combining weight may include N elements corresponding to each antenna or antenna portion. For example, w_{N} may consist of N elements, where each element of w_{N}Wy may have a value −1 except for the Nth element of w_{N} which may have a value 1. Each flip-over combining weight may be unique to the respective antenna or antenna portion such that the UE 115-g may identify the phase, amplitude, and panel location (e.g., antenna or antenna portion) of a received signal, thereby providing the UE 115-g with sufficient information to determine a signal strength distribution at the receiving antenna panel. Combining the signals received from each antenna or antenna portion with such weights may result in one or more channel response values.

In some examples, the UE 115-g may determine a signal strength distribution using a phase shifter combiner which the UE 115-g may use to combine the signals received from each antenna or antenna portion with the flip-over combining weights, resulting in one or more channel response values. The phase shifter combiner may have a lower complexity as compared to a combiner adjusting both phase and amplitude of a received signal weight. As an illustrative example, the UE 115-g may combine the signals from the one or more antennas or antenna portions using the flip-over combining weights illustrated by Equation 2:

$$\frac{{w}_{0} y + {w}_{i} y}{2 x} = \frac{( {\sum }_{j = 1}^{N} {y}_{j} ) + ( {y}_{i} - {\sum }_{j = 1 , j \neq i}^{N} {y}_{j} )}{2 x} = \frac{{y}_{i}}{x} = {\hat{h}}_{i} \qquad ( 2 )$$

In Equation 2, wᵢ may be a flip-over combining weight associated with a respective antenna or antenna portion with an index i. For example, w₀ may be a flip-over combining weight associated with a respective antenna or antenna portion with an index 0. The term y may be a received signal on the entirety of the receiving antenna panel, or at least the received signal across all antennas or antenna portions of the receiving antenna panel. Further, the term x may be a reference signal received at the receiving antenna panel. As such, Equation 2 describes combining the received signal y at an antenna portion with an index i, with the respective flip-over combining weight wᵢ (and normalizing the combination with a reference signal x, resulting in a channel response value ĥᵢ associated with receiving a downlink signal at antenna or antenna portion i.

In some examples, the UE 115-g may combine the channel response values ĥᵢ, resulting in a received beamforming (e.g., or combining) weight. As an illustrative example, a received beamforming weight is illustrated by Equation 3:

$$[ {e}^{( - j \cdot phase ( {\hat{h}}_{1} ) )} , … , {e}^{( - j \cdot phase ( {\hat{h}}_{N} ) )} ] \qquad ( 3 )$$

In Equation 3, ĥ_{N} may be a channel response value acquired by combining received signals with flip-over combining weights associated with each respective antenna or antenna portion, where ĥ_{N} may correspond to an antenna or antenna portion with an index N. The parameter j may represent an imaginary unit such that j²=−1. Equation 3 may describe a received beamforming weight representing the signal strength distribution for a received signal at a receiving antenna panel.

At 415, the UE 115-g may determine beam adjustment information, for example, using the received beamforming weight in Equation 3. In some examples, the beam adjustment information may include a value Y beamwidth, which may be a ratio of a target beam width, such as the width of the receiving antenna panel, and the current beam width, such as the beam width determined using the received signal strengths from each antenna or antenna portion. In another example, the beam adjustment information may include a variance of the signal strengths from each antenna or antenna portion in the receiving antenna panel. To determine the variance, the UE 115-b may determine the mean signal strength value of the received signal averaging the signal strength values from each antenna or antenna portion. As an illustrative example, the UE 115-g may determine the mean signal strength value and the variance by Equation 4:

$${μ}_{h} = \frac{1}{N} {\sum }_{n = 1}^{N} {\hat{h}}_{n} ; \qquad ( 4 )$$

$${ρ}_{h} = \sqrt{\frac{1}{N} {\sum }_{n = 1}^{N} {( {\hat{h}}_{n} - {μ}_{h} )}^{2}}$$

In Equation 4, μₙ may be the mean signal strength value of the received signal in the receiving antenna panel. The mean signal strength value un may be determined by averaging the signal strengths ĥₙ from each antenna or antenna portion. The ρₕ term may be the variance of the signal strengths in the receiving antenna panel. In some examples, ρₕ may be representative of the signal strength fluctuation in the receiving antenna panel, where for increasing ρₕ, the signal strength in the receiving panel may fluctuate to a greater degree, indicating a small beam width (e.g., as compared to a beam width corresponding to a relatively low variance).

At 420, the UE 115-g may transmit a report to the base station 105-b, which may include the beam adjustment information. In some examples, the UE 115-g may report the beam adjustment information as an adjustment degree, informing the base station 105-b of a received signal strength, a target signal strength, or the like. The UE 115-g may determine the adjustment degree using, or otherwise based on, the ratio between the target beam width and the current beam width (e.g., γ_{beamwidth}), the variance in the receiving antenna panel (e.g., ρₕ), and the like. In some cases, the adjustment degree may be one of a set of quantized values corresponding to respective decibel (dB) values (e.g., ×1 (0 dB), ×2 (3 dB), ×4 (6 dB)). Additionally or alternatively, the UE 115-g may report the beam adjustment information as beam width distribution information. For example, the UE 115-g may transmit the beam adjustment information to the base station 105-b including the variance of the signal strengths (e.g., quantized as 0 dB, 3 dB, 6 dB) in the receiving antenna panel, informing the base station 105-b how equal (or unequal) the signal is distributed at the receiving antenna panel. In some examples, the UE 115-g may include both the adjustment degree and the beam width distribution information in the beam adjustment information. In some examples, the UE 115-g may transmit the report in RRC signaling, a MAC control element (MAC-CE) message, or a physical layer message, such as uplink control information (UCI). In some examples, the UE 115-g may report the beam adjustment information in a CSI report.

At 425, the base station 105-b may adjust a beam width, for example, in accordance with, or otherwise referencing, the beam adjustment information received at 420. In some examples, the base station 105-b may generate a new beam based on the received beam adjustment information. For example, the base station 105-b may transmit a wider beam with a wide-beam weight at a transmitter panel, the base station 105-b may target a beam location at a spot farther than the UE 115-g (e.g., a distance greater than the distance between the base station 105-b and the UE 115-g), or any other means of adjusting the beam width to increase the signal strength distribution at the receiving antenna panel of the UE 115-g. In some examples, the base station 105-b may adjust the beam based on one or more values within the beam adjustment information. For example, in some cases, the beam adjustment information may include a positive beam adjustment indicator and the base station 105-b may determine to expand the beam width. In some cases, the beam adjustment indicator may be equal to zero, and the base station 105-b may determine to refrain from adjusting the beam width. In some cases, the beam adjustment indicator may be a negative value and the base station 105-b may determine to shrink, or decrease, the beam width at the location of the UE 115-g. In any case, the base station 105-b may generate the adjusted beam in substantially the same direction as the previous beam to provide coverage to the UE 115-g reporting the beam adjustment information. By way of example, the UE 115-g may determine that a receiving antenna panel receives a signal with an uneven power distribution, indicating that a beam width is too small at the location of the UE 115-g. As such, the UE 115-g may transmit beam adjustment information to the base station 105-b indicating the uneven power distribution, where the base station 105-b may receive the beam adjustment information and adjust the beam width at the location of the UE 115-g. In such an example, the base station 105-b may target transmit power at a spot further from the UE 115-g (e.g., increasing a targeting distance) which may result in increased signal strength distribution at the receiving antenna panel of the UE 115-g.

At 430, the base station 105-b may transmit a downlink signal using the adjusted beam, to the UE 115-g. In some examples, the UE 115-g may receive the downlink signal with a greater throughput and a higher receive power as compared to receiving a downlink signal from the previous beam, for example, used at 405.

Configuring the UE 115-g and the base station 105-b to adjust 3D beamforming beam widths using the beam width adjustment scheme as described herein may resolve a mismatch between the beam width of a 3D beam and a receiving antenna panel at the UE 115-g, increasing beamforming gain, boosting a data rate of such H-MIMO systems. Further, compared to 3D beam sweeping procedures, adjusting communication beams using UE 115-g feedback may reduce beam adjustment latency, increase transmission accuracy, among other benefits.

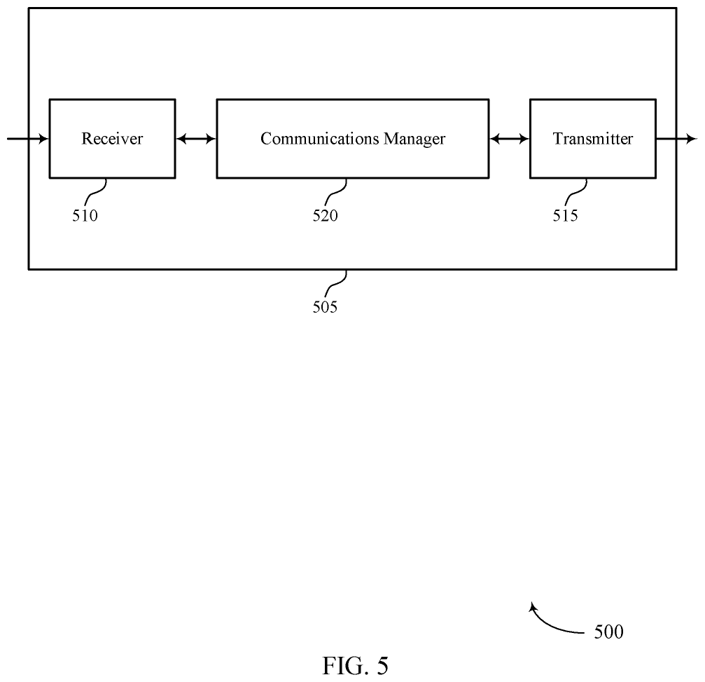

FIG. 5 shows a block diagram 500 of a device 505 that supports techniques for beam width adjustment in beamforming communications in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for beam width adjustment in beamforming communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for beam width adjustment in beamforming communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for beam width adjustment in beamforming communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for receiving, from a base station, a beamformed signal via a beam within a distance threshold for MIMO communications from the base station. The communications manager 520 may be configured as or otherwise support a means for transmitting, to the base station, a report indicating a beam adjustment parameter based on a signal distribution of the beamformed signal at an antenna panel of the UE.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing, reduced power consumption, or more efficient utilization of communication resources.

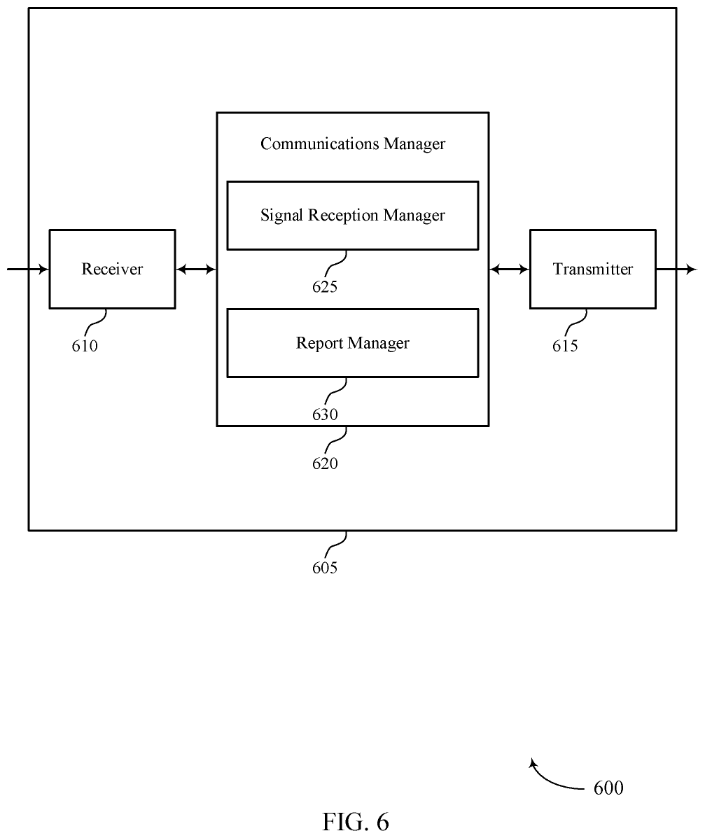

FIG. 6 shows a block diagram 600 of a device 605 that supports techniques for beam width adjustment in beamforming communications in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for beam width adjustment in beamforming communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for beam width adjustment in beamforming communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for beam width adjustment in beamforming communications as described herein. For example, the communications manager 620 may include a signal reception manager 625 a report manager 630, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The signal reception manager 625 may be configured as or otherwise support a means for receiving, from a base station, a beamformed signal via a beam within a distance threshold for MIMO communications from the base station. The report manager 630 may be configured as or otherwise support a means for transmitting, to the base station, a report indicating a beam adjustment parameter based on a signal distribution of the beamformed signal at an antenna panel of the UE.

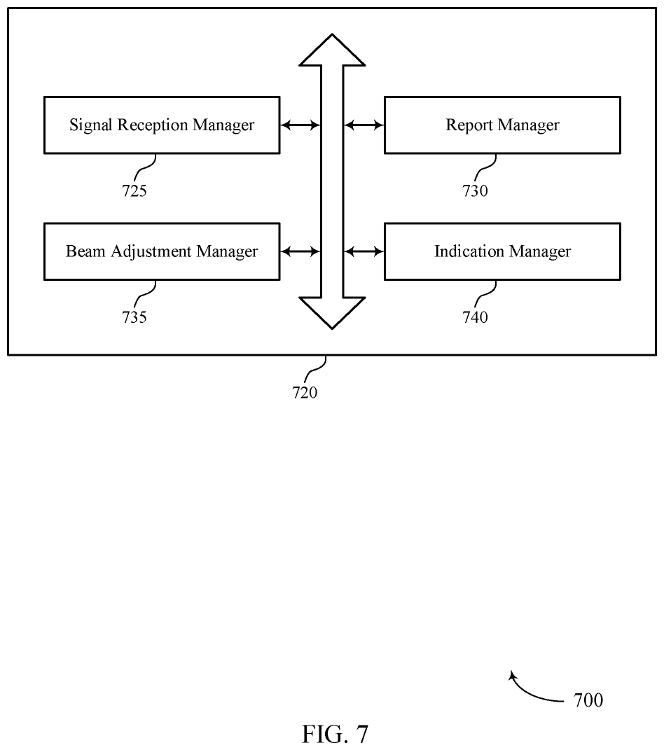

FIG. 7 shows a block diagram 700 of a communications manager 720 that supports techniques for beam width adjustment in beamforming communications in accordance with aspects of the present disclosure. The communications manager 720 may be an example of aspects of a communications manager 520, a communications manager 620, or both, as described herein. The communications manager 720, or various components thereof, may be an example of means for performing various aspects of techniques for beam width adjustment in beamforming communications as described herein. For example, the communications manager 720 may include a signal reception manager 725, a report manager 730, a beam adjustment manager 735, an indication manager 740, or any combination thereof. Each of these components may communicate, directly or indirectly, with one another (e.g., via one or more buses).

The communications manager 720 may support wireless communications at a UE in accordance with examples as disclosed herein. The signal reception manager 725 may be configured as or otherwise support a means for receiving, from a base station, a beamformed signal via a beam within a distance threshold for MIMO communications from the base station. The report manager 730 may be configured as or otherwise support a means for transmitting, to the base station, a report indicating a beam adjustment parameter based on a signal distribution of the beamformed signal at an antenna panel of the UE.

In some examples, the beam adjustment manager 735 may be configured as or otherwise support a means for calculating a set of channel response values, each channel response value associated with a respective element of a set of elements at the antenna panel, where the beam adjustment parameter is based on the set of channel response values.

In some examples, the beam adjustment manager 735 may be configured as or otherwise support a means for determining a beam width of the beam based on a set of received signal strength values, each received signal strength value associated with a respective element of a set of elements at the antenna panel, where the beam adjustment parameter is based on a ratio associated with the determined beam width and a target beam width.

In some examples, the beam adjustment manager 735 may be configured as or otherwise support a means for determining a signal strength variance based on a set of received signal strength values, each received signal strength value associated with a respective element of a set of elements at the antenna panel, where the beam adjustment parameter is based on the signal strength variance.

In some examples, the signal reception manager 725 may be configured as or otherwise support a means for receiving, from the base station, a second beamformed signal via a second beam within the near field of the MIMO communications, the second beam based on the beam adjustment parameter in the transmitted report.

In some examples, a beam width of the second beam is based on a value of the beam adjustment parameter.

In some examples, the indication manager 740 may be configured as or otherwise support a means for receiving, from the base station, an indication that the UE is located within the distance threshold for MIMO communications from the base station, where receiving the beamformed signal is based on receiving the indication.

In some examples, the report is transmitted in a radio resource control message, a MAC-CE, a physical layer message, a CSI message, or any combination thereof. In some examples, the beamformed signal includes a data signal, a reference signal, or both. In some examples, the distance threshold is based on a size of an antenna panel at the base station, a wavelength associated with the beam, or both.

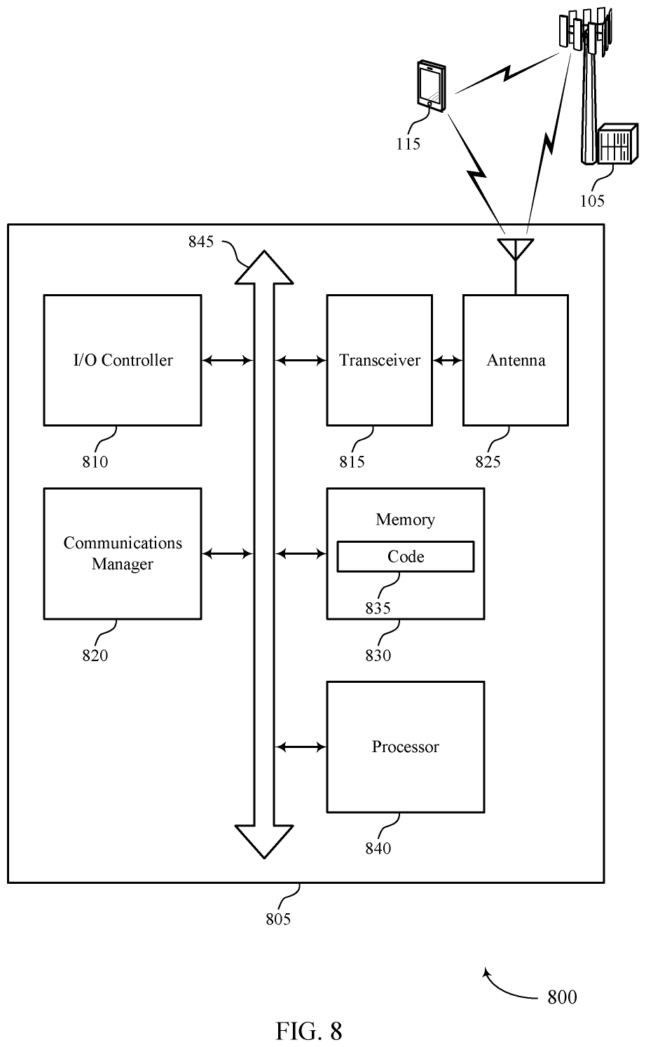

FIG. 8 shows a diagram of a system 800 including a device 805 that supports techniques for beam width adjustment in beamforming communications in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for beam width adjustment in beamforming communications). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving, from a base station, a beamformed signal via a beam within a distance threshold for MIMO communications from the base station. The communications manager 820 may be configured as or otherwise support a means for transmitting, to the base station, a report indicating a beam adjustment parameter based on a signal distribution of the beamformed signal at an antenna panel of the UE.

By including or configuring the communications manager 820 in accordance with examples as described herein, the device 805 may support techniques for reduced latency, reduced power consumption, more efficient utilization of communication resources, improved coordination between devices, longer battery life, improved utilization of processing capability, etc.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for beam width adjustment in beamforming communications as described herein, or the processor 840 and the memory 830 may be otherwise configured to perform or support such operations.

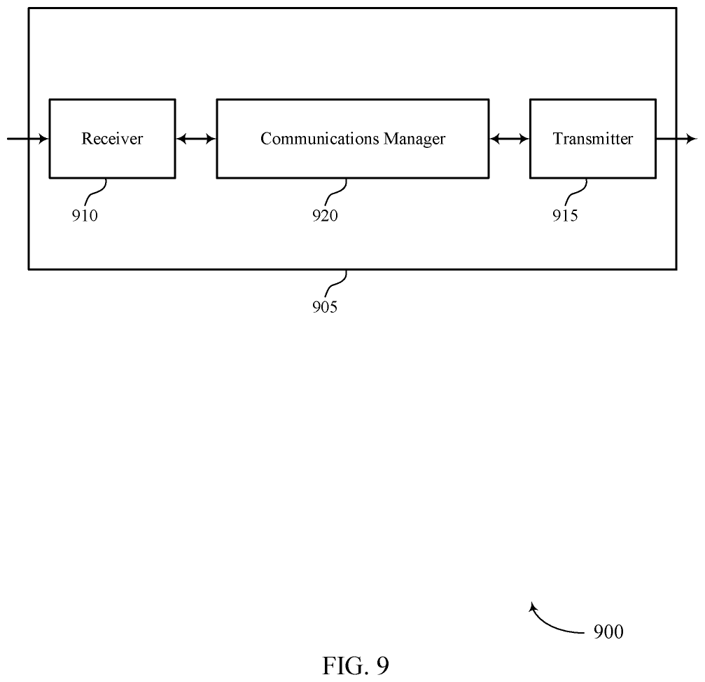

FIG. 9 shows a block diagram 900 of a device 905 that supports techniques for beam width adjustment in beamforming communications in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for beam width adjustment in beamforming communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for beam width adjustment in beamforming communications). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of techniques for beam width adjustment in beamforming communications as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for transmitting, to a UE, a beamformed signal via a beam within a distance threshold for MIMO communications from the base station. The communications manager 920 may be configured as or otherwise support a means for receiving, from the UE, a report indicating a beam adjustment parameter based on a signal distribution of the beamformed signal at an antenna panel of the UE.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced processing, reduced power consumption, or more efficient utilization of communication resources.

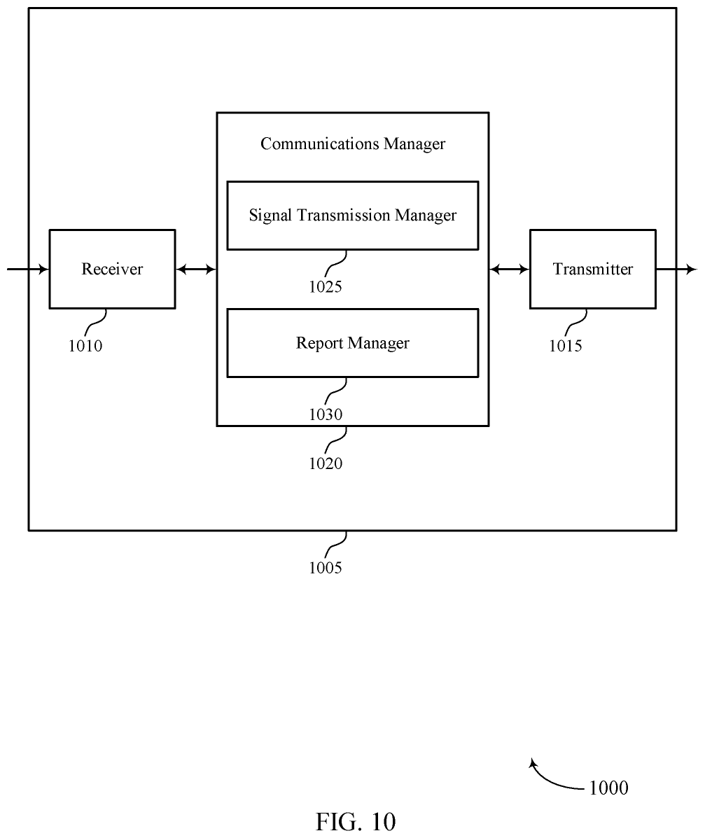

FIG. 10 shows a block diagram 1000 of a device 1005 that supports techniques for beam width adjustment in beamforming communications in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for beam width adjustment in beamforming communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for beam width adjustment in beamforming communications). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for beam width adjustment in beamforming communications as described herein. For example, the communications manager 1020 may include a signal transmission manager 1025 a report manager 1030, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The signal transmission manager 1025 may be configured as or otherwise support a means for transmitting, to a UE, a beamformed signal via a beam within a distance threshold for MIMO communications from the base station. The report manager 1030 may be configured as or otherwise support a means for receiving, from the UE, a report indicating a beam adjustment parameter based on a signal distribution of the beamformed signal at an antenna panel of the UE.

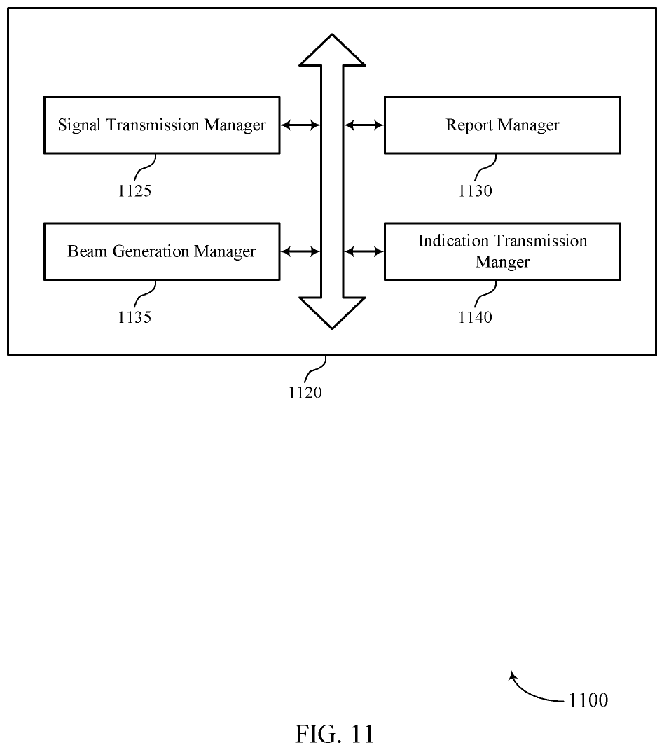

FIG. 11 shows a block diagram 1100 of a communications manager 1120 that supports techniques for beam width adjustment in beamforming communications in accordance with aspects of the present disclosure. The communications manager 1120 may be an example of aspects of a communications manager 920, a communications manager 1020, or both, as described herein. The communications manager 1120, or various components thereof, may be an example of means for performing various aspects of techniques for beam width adjustment in beamforming communications as described herein. For example, the communications manager 1120 may include a signal transmission manager 1125, a report manager 1130, a beam generation manager 1135, an indication transmission manger 1140, or any combination thereof. Each of these components may communicate, directly or indirectly, with one another (e.g., via one or more buses).

The communications manager 1120 may support wireless communications at a base station in accordance with examples as disclosed herein. The signal transmission manager 1125 may be configured as or otherwise support a means for transmitting, to a UE, a beamformed signal via a beam within a distance threshold for MIMO communications from the base station. The report manager 1130 may be configured as or otherwise support a means for receiving, from the UE, a report indicating a beam adjustment parameter based on a signal distribution of the beamformed signal at an antenna panel of the UE.

In some examples, the beam generation manager 1135 may be configured as or otherwise support a means for generating a second beam based on the beam adjustment parameter in the received report. In some examples, the signal transmission manager 1125 may be configured as or otherwise support a means for transmitting, to the UE, a second beamformed signal via the second beam within the near field of the MIMO communications.

In some examples, a beam weight, a target distance, a beam width, or any combination thereof, of the generated second beam are based on a value of the beam adjustment parameter.

In some examples, the beam is generated at a first antenna panel at the base station. In some examples, the second beam is generated at a second antenna panel at the base station different from the first antenna panel.

In some examples, the beam is generated using a first beamforming weight vector. In some examples, the second beam is generated using a second beamforming weight vector different from the first beamforming weight vector.

In some examples, the beam adjustment parameter includes a set of channel response values.

In some examples, the beam adjustment parameter includes a beam width ratio value.

In some examples, the beam adjustment parameter includes a signal strength variance value.

In some examples, the indication transmission manger 1140 may be configured as or otherwise support a means for transmitting, to the UE, an indication that the UE is located within the distance threshold for MIMO communications from the base station, where transmitting the beamformed signal is based on transmitting the indication.

In some examples, the report is received in a radio resource control message, a MAC-CE, a physical layer message, a CSI message, or any combination thereof. In some examples, the beamformed signal includes a data signal, a reference signal, or both. In some examples, the distance threshold is based on a size of an antenna panel at the base station, a wavelength associated with the beam, or both.

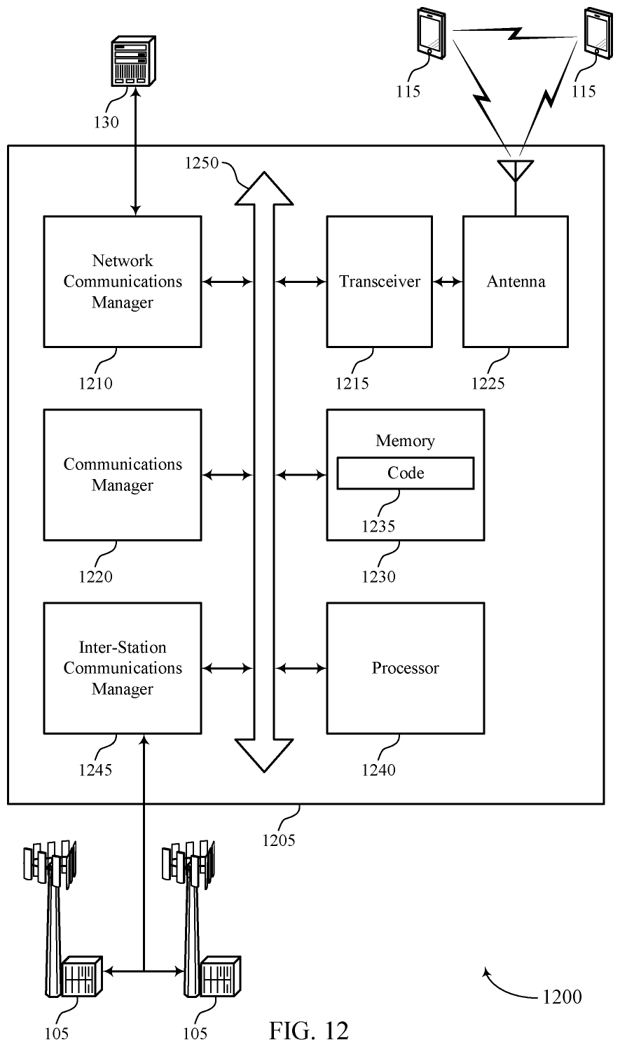

FIG. 12 shows a diagram of a system 1200 including a device 1205 that supports techniques for beam width adjustment in beamforming communications in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting techniques for beam width adjustment in beamforming communications). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for transmitting, to a UE, a beamformed signal via a beam within a distance threshold for MIMO communications from the base station. The communications manager 1220 may be configured as or otherwise support a means for receiving, from the UE, a report indicating a beam adjustment parameter based on a signal distribution of the beamformed signal at an antenna panel of the UE.

By including or configuring the communications manager 1220 in accordance with examples as described herein, the device 1205 may support techniques for improved communication reliability, reduced latency, reduced power consumption, more efficient utilization of communication resources, improved coordination between devices, improved utilization of processing capability, etc.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for beam width adjustment in beamforming communications as described herein, or the processor 1240 and the memory 1230 may be otherwise configured to perform or support such operations.

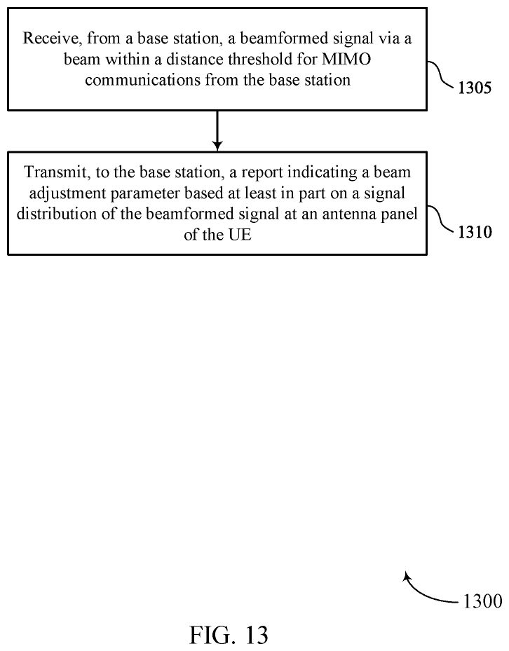

FIG. 13 shows a flowchart illustrating a method 1300 that supports techniques for beam width adjustment in beamforming communications in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, a beamformed signal via a beam within a distance threshold for MIMO communications from the base station. The operations of 1305 may be performed in accordance with examples as disclosed herein. In some examples, aspects of the operations of 1305 may be performed by a signal reception manager 725 as described with reference to FIG. 7.

At 1310, the method may include transmitting, to the base station, a report indicating a beam adjustment parameter based on a signal distribution of the beamformed signal at an antenna panel of the UE. The operations of 1310 may be performed in accordance with examples as disclosed herein. In some examples, aspects of the operations of 1310 may be performed by a report manager 730 as described with reference to FIG. 7.

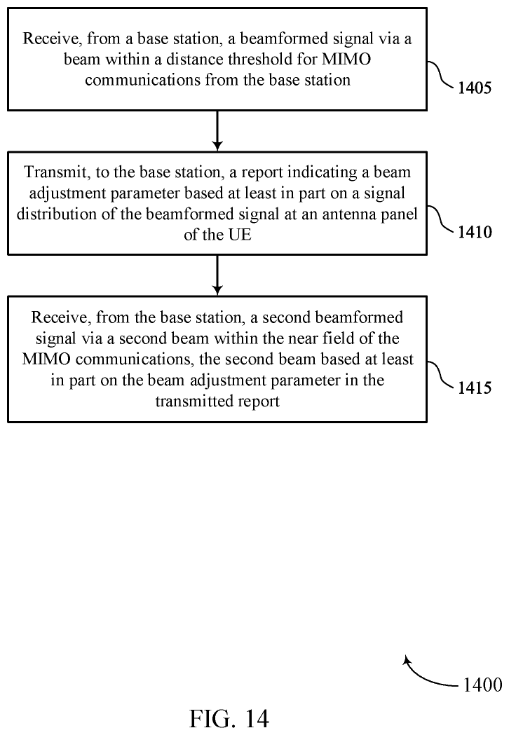

FIG. 14 shows a flowchart illustrating a method 1400 that supports techniques for beam width adjustment in beamforming communications in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, a beamformed signal via a beam within a distance threshold for MIMO communications from the base station. The operations of 1405 may be performed in accordance with examples as disclosed herein. In some examples, aspects of the operations of 1405 may be performed by a signal reception manager 725 as described with reference to FIG. 7.

At 1410, the method may include transmitting, to the base station, a report indicating a beam adjustment parameter based on a signal distribution of the beamformed signal at an antenna panel of the UE. The operations of 1410 may be performed in accordance with examples as disclosed herein. In some examples, aspects of the operations of 1410 may be performed by a report manager 730 as described with reference to FIG. 7.

At 1415, the method may include receiving, from the base station, a second beamformed signal via a second beam within the near field of the MIMO communications, the second beam based on the beam adjustment parameter in the transmitted report. The operations of 1415 may be performed in accordance with examples as disclosed herein. In some examples, aspects of the operations of 1415 may be performed by a signal reception manager 725 as described with reference to FIG. 7.

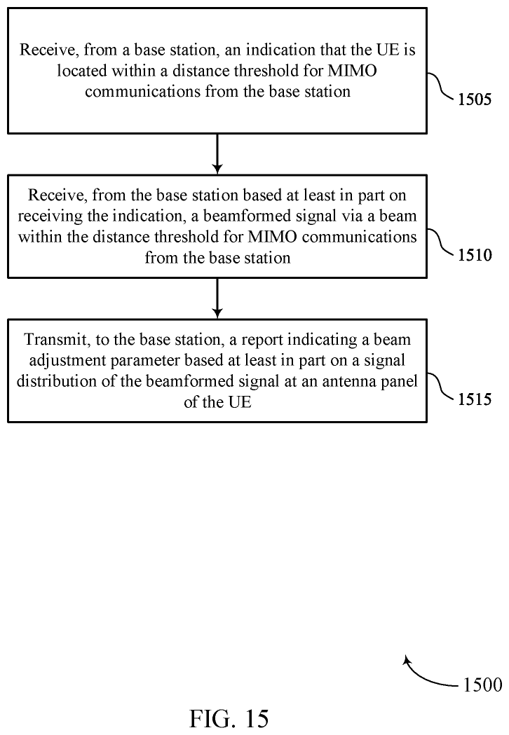

FIG. 15 shows a flowchart illustrating a method 1500 that supports techniques for beam width adjustment in beamforming communications in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, an indication that the UE is located within a distance threshold for MIMO communications from the base station. The operations of 1505 may be performed in accordance with examples as disclosed herein. In some examples, aspects of the operations of 1505 may be performed by an indication manager 740 as described with reference to FIG. 7.

At 1510, the method may include receiving, from the base station based on receiving the indication, a beamformed signal via a beam within the distance threshold for MIMO communications from the base station. The operations of 1510 may be performed in accordance with examples as disclosed herein. In some examples, aspects of the operations of 1510 may be performed by a signal reception manager 725 as described with reference to FIG. 7.

At 1515, the method may include transmitting, to the base station, a report indicating a beam adjustment parameter based on a signal distribution of the beamformed signal at an antenna panel of the UE. The operations of 1515 may be performed in accordance with examples as disclosed herein. In some examples, aspects of the operations of 1515 may be performed by a report manager 730 as described with reference to FIG. 7.

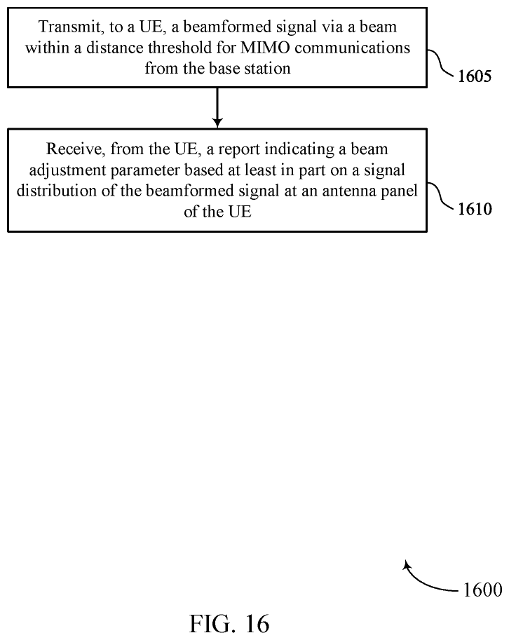

FIG. 16 shows a flowchart illustrating a method 1600 that supports techniques for beam width adjustment in beamforming communications in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, a beamformed signal via a beam within a distance threshold for MIMO communications from the base station. The operations of 1605 may be performed in accordance with examples as disclosed herein. In some examples, aspects of the operations of 1605 may be performed by a signal transmission manager 1125 as described with reference to FIG. 11.

At 1610, the method may include receiving, from the UE, a report indicating a beam adjustment parameter based on a signal distribution of the beamformed signal at an antenna panel of the UE. The operations of 1610 may be performed in accordance with examples as disclosed herein. In some examples, aspects of the operations of 1610 may be performed by a report manager 1130 as described with reference to FIG. 11.

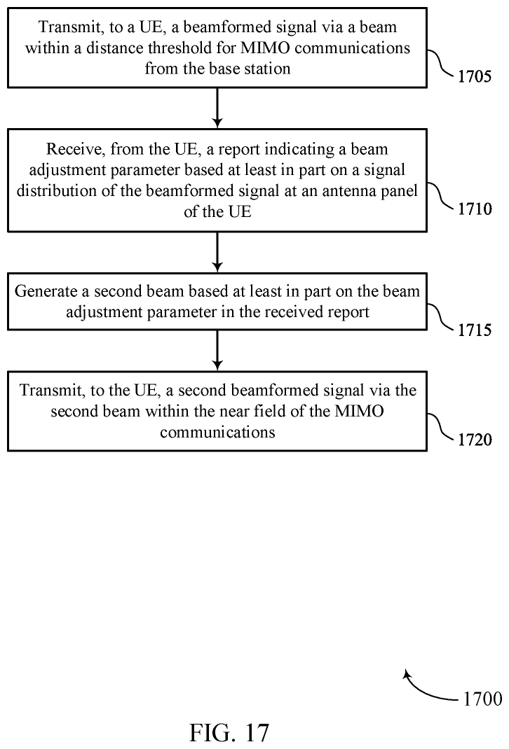

FIG. 17 shows a flowchart illustrating a method 1700 that supports techniques for beam width adjustment in beamforming communications in accordance with aspects of the present disclosure. The operations of the method 1700 may be implemented by a base station or its components as described herein. For example, the operations of the method 1700 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, a beamformed signal via a beam within a distance threshold for MIMO communications from the base station. The operations of 1705 may be performed in accordance with examples as disclosed herein. In some examples, aspects of the operations of 1705 may be performed by a signal transmission manager 1125 as described with reference to FIG. 11.

At 1710, the method may include receiving, from the UE, a report indicating a beam adjustment parameter based on a signal distribution of the beamformed signal at an antenna panel of the UE. The operations of 1710 may be performed in accordance with examples as disclosed herein. In some examples, aspects of the operations of 1710 may be performed by a report manager 1130 as described with reference to FIG. 11.

At 1715, the method may include generating a second beam based on the beam adjustment parameter in the received report. The operations of 1715 may be performed in accordance with examples as disclosed herein. In some examples, aspects of the operations of 1715 may be performed by a beam generation manager 1135 as described with reference to FIG. 11.

At 1720, the method may include transmitting, to the UE, a second beamformed signal via the second beam within the near field of the MIMO communications. The operations of 1720 may be performed in accordance with examples as disclosed herein. In some examples, aspects of the operations of 1720 may be performed by a signal transmission manager 1125 as described with reference to FIG. 11.

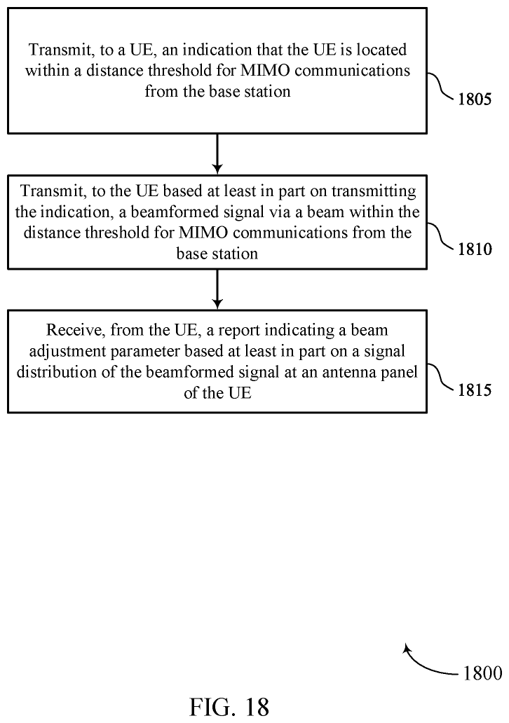

FIG. 18 shows a flowchart illustrating a method 1800 that supports techniques for beam width adjustment in beamforming communications in accordance with aspects of the present disclosure. The operations of the method 1800 may be implemented by a base station or its components as described herein. For example, the operations of the method 1800 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1805, the method may include transmitting, to a UE, an indication that the UE is located within a distance threshold for MIMO communications from the base station. The operations of 1805 may be performed in accordance with examples as disclosed herein. In some examples, aspects of the operations of 1805 may be performed by an indication transmission manger 1140 as described with reference to FIG. 11.

At 1810, the method may include transmitting, to the UE based at least in part on transmitting the indication, a beamformed signal via a beam within the distance threshold for MIMO communications from the base station. The operations of 1810 may be performed in accordance with examples as disclosed herein. In some examples, aspects of the operations of 1810 may be performed by a signal transmission manager 1125 as described with reference to FIG. 11.

At 1815, the method may include receiving, from the UE, a report indicating a beam adjustment parameter based on a signal distribution of the beamformed signal at an antenna panel of the UE. The operations of 1815 may be performed in accordance with examples as disclosed herein. In some examples, aspects of the operations of 1815 may be performed by a report manager 1130 as described with reference to FIG. 11.

The following provides an overview of aspects of the present disclosure:
Aspect 1: A method for wireless communications at a UE, comprising: receiving, from a base station, a beamformed signal via a beam within a distance threshold for multiple-input multiple-output (MIMO) communications from the base station: and transmitting, to the base station, a report indicating a beam adjustment parameter based at least in part on a signal distribution of the beamformed signal at an antenna panel of the UE.
Aspect 2: The method of aspect 1, further comprising: calculating a set of channel response values, each channel response value associated with a respective element of a set of elements at the antenna panel, wherein the beam adjustment parameter is based at least in part on the set of channel response values.
Aspect 3: The method of any of aspects 1 through 2, further comprising: determining a beam width of the beam based at least in part on a set of received signal strength values, each received signal strength value associated with a respective element of a set of elements at the antenna panel, wherein the beam adjustment parameter is based at least in part on a ratio associated with the determined beam width and a target beam width.
Aspect 4: The method of any of aspects 1 through 3, further comprising: determining a signal strength variance based at least in part on a set of received signal strength values, each received signal strength value associated with a respective element of a set of elements at the antenna panel, wherein the beam adjustment parameter is based at least in part on the signal strength variance.
Aspect 5: The method of any of aspects 1 through 4, further comprising: receiving, from the base station, a second beamformed signal via a second beam within the near field of the MIMO communications, the second beam based at least in part on the beam adjustment parameter in the transmitted report.
Aspect 6: The method of aspect 5, wherein a beam width of the second beam is based at least in part on a value of the beam adjustment parameter.
Aspect 7: The method of any of aspects 1 through 6, further comprising: receiving, from the base station, an indication that the UE is located within the distance threshold for MIMO communications from the base station, wherein receiving the beamformed signal is based at least in part on receiving the indication.
Aspect 8: The method of any of aspects 1 through 7, wherein the report is transmitted in a radio resource control message, a medium access control control element, a physical layer message, a channel state information message, or any combination thereof.
Aspect 9: The method of any of aspects 1 through 8, wherein the beamformed signal comprises a data signal, a reference signal, or both.
Aspect 10: The method of any of aspects 1 through 9, wherein the distance threshold is based at least in part on a size of an antenna panel at the base station, a wavelength associated with the beam, or both.
Aspect 11: A method for wireless communications at a base station, comprising: transmitting, to a UE, a beamformed signal via a beam within a distance threshold for multiple-input multiple-output (MIMO) communications from the base station: and receiving, from the UE, a report indicating a beam adjustment parameter based at least in part on a signal distribution of the beamformed signal at an antenna panel of the UE.
Aspect 12: The method of aspect 11, further comprising: generating a second beam based at least in part on the beam adjustment parameter in the received report: and transmitting, to the UE, a second beamformed signal via the second beam within the near field of the MIMO communications.
Aspect 13: The method of aspect 12, wherein a beam weight, a target distance, a beam width, or any combination thereof, of the generated second beam are based at least in part on a value of the beam adjustment parameter.
Aspect 14: The method of any of aspects 12 through 13, wherein the beam is generated at a first antenna panel at the base station; and the second beam is generated at a second antenna panel at the base station different from the first antenna panel.
Aspect 15: The method of any of aspects 12 through 14, wherein the beam is generated using a first beamforming weight vector; and the second beam is generated using a second beamforming weight vector different from the first beamforming weight vector.
Aspect 16: The method of any of aspects 11 through 15, wherein the beam adjustment parameter comprises a set of channel response values.
Aspect 17: The method of any of aspects 11 through 16, wherein the beam adjustment parameter comprises a beam width ratio value.
Aspect 18: The method of any of aspects 11 through 17, wherein the beam adjustment parameter comprises a signal strength variance value.
Aspect 19: The method of any of aspects 11 through 18, further comprising: transmitting, to the UE, an indication that the UE is located within the distance threshold for MIMO communications from the base station, wherein transmitting the beamformed signal is based at least in part on transmitting the indication.
Aspect 20: The method of any of aspects 11 through 19, wherein the report is received in a radio resource control message, a medium access control control element, a physical layer message, a channel state information message, or any combination thereof.
Aspect 21: The method of any of aspects 11 through 20, wherein the beamformed signal comprises a data signal, a reference signal, or both.
Aspect 22: The method of any of aspects 11 through 21, wherein the distance threshold is based at least in part on a size of an antenna panel at the base station, a wavelength associated with the beam, or both.
Aspect 23: An apparatus for wireless communications at a UE, comprising a processor; memory coupled with the processor; and instructions stored in the memory and executable by the processor to cause the apparatus to perform a method of any of aspects 1 through 10.
Aspect 24: An apparatus for wireless communications at a UE, comprising at least one means for performing a method of any of aspects 1 through 10.
Aspect 25: A non-transitory computer-readable medium storing code for wireless communications at a UE, the code comprising instructions executable by a processor to perform a method of any of aspects 1 through 10.
Aspect 26: An apparatus for wireless communications at a base station, comprising a processor; memory coupled with the processor; and instructions stored in the memory and executable by the processor to cause the apparatus to perform a method of any of aspects 11 through 22.
Aspect 27: An apparatus for wireless communications at a base station, comprising at least one means for performing a method of any of aspects 11 through 22.
Aspect 28: A non-transitory computer-readable medium storing code for wireless communications at a base station, the code comprising instructions executable by a processor to perform a method of any of aspects 11 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, a beamformed signal via a beam within a distance threshold for multiple-input multiple-output (MIMO) communications from the base station; and
transmitting, to the base station, a report indicating a beam adjustment parameter based at least in part on a signal distribution of the beamformed signal at an antenna panel of the UE.

2. The method of claim 1, further comprising:
calculating a set of channel response values, each channel response value associated with a respective element of a set of elements at the antenna panel, wherein the beam adjustment parameter is based at least in part on the set of channel response values.

3. The method of claim 1, further comprising:
determining a beam width of the beam based at least in part on a set of received signal strength values, each received signal strength value associated with a respective element of a set of elements at the antenna panel, wherein the beam adjustment parameter is based at least in part on a ratio associated with the determined beam width and a target beam width.

4. The method of claim 1, further comprising:
determining a signal strength variance based at least in part on a set of received signal strength values, each received signal strength value associated with a respective element of a set of elements at the antenna panel, wherein the beam adjustment parameter is based at least in part on the signal strength variance.

5. The method of claim 1, further comprising:
receiving, from the base station, a second beamformed signal via a second beam within the near field of the MIMO communications, the second beam based at least in part on the beam adjustment parameter in the transmitted report.

6. The method of claim 5, wherein a beam width of the second beam is based at least in part on a value of the beam adjustment parameter.

7. The method of claim 1, further comprising:
receiving, from the base station, an indication that the UE is located within the distance threshold for MIMO communications from the base station, wherein receiving the beamformed signal is based at least in part on receiving the indication.

8. The method of claim 1, wherein the report is transmitted in a radio resource control message, a medium access control control element, a physical layer message, a channel state information message, or any combination thereof.

9. The method of claim 1, wherein the beamformed signal comprises a data signal, a reference signal, or both.

10. The method of claim 1, wherein the distance threshold is based at least in part on a size of an antenna panel at the base station, a wavelength associated with the beam, or both.

11. A method for wireless communications at a base station, comprising:
transmitting, to a user equipment (UE), a beamformed signal via a beam within a distance threshold for multiple-input multiple-output (MIMO) communications from the base station; and
receiving, from the UE, a report indicating a beam adjustment parameter based at least in part on a signal distribution of the beamformed signal at an antenna panel of the UE.

12. The method of claim 11, further comprising:
generating a second beam based at least in part on the beam adjustment parameter in the received report; and
transmitting, to the UE, a second beamformed signal via the second beam within the near field of the MIMO communications.

13. The method of claim 12, wherein a beam weight, a target distance, a beam width, or any combination thereof, of the generated second beam are based at least in part on a value of the beam adjustment parameter.

14. The method of claim 12, wherein:
the beam is generated at a first antenna panel at the base station; and
the second beam is generated at a second antenna panel at the base station different from the first antenna panel.

15. The method of claim 12, wherein:
the beam is generated using a first beamforming weight vector; and
the second beam is generated using a second beamforming weight vector different from the first beamforming weight vector.

16. The method of claim 11, wherein the beam adjustment parameter comprises a set of channel response values.

17. The method of claim 11, wherein the beam adjustment parameter comprises a beam width ratio value.

18. The method of claim 11, wherein the beam adjustment parameter comprises a signal strength variance value.

19. The method of claim 11, further comprising:
transmitting, to the UE, an indication that the UE is located within the distance threshold for MIMO communications from the base station, wherein transmitting the beamformed signal is based at least in part on transmitting the indication.

20. The method of claim 11, wherein the report is received in a radio resource control message, a medium access control control element, a physical layer message, a channel state information message, or any combination thereof.

21. The method of claim 11, wherein the beamformed signal comprises a data signal, a reference signal, or both.

22. The method of claim 11, wherein the distance threshold is based at least in part on a size of an antenna panel at the base station, a wavelength associated with the beam, or both.

23. An apparatus for wireless communications at a user equipment (UE), comprising:
a processor;
memory coupled with the processor; and
instructions stored in the memory and executable by the processor to cause the apparatus to:
receive, from a base station, a beamformed signal via a beam within a distance threshold for multiple-input multiple-output (MIMO) communications from the base station; and
transmit, to the base station, a report indicating a beam adjustment parameter based at least in part on a signal distribution of the beamformed signal at an antenna panel of the UE.

24. The apparatus of claim 23, wherein the instructions are further executable by the processor to cause the apparatus to:
calculate a set of channel response values, each channel response value associated with a respective element of a set of elements at the antenna panel, wherein the beam adjustment parameter is based at least in part on the set of channel response values.

25. The apparatus of claim 23, wherein the instructions are further executable by the processor to cause the apparatus to:
determine a beam width of the beam based at least in part on a set of received signal strength values, each received signal strength value associated with a respective element of a set of elements at the antenna panel, wherein the beam adjustment parameter is based at least in part on a ratio associated with the determined beam width and a target beam width.

26. The apparatus of claim 23, wherein the instructions are further executable by the processor to cause the apparatus to:
determine a signal strength variance based at least in part on a set of received signal strength values, each received signal strength value associated with a respective element of a set of elements at the antenna panel, wherein the beam adjustment parameter is based at least in part on the signal strength variance.

27. The apparatus of claim 23, wherein the instructions are further executable by the processor to cause the apparatus to:
receive, from the base station, a second beamformed signal via a second beam within the near field of the MIMO communications, the second beam based at least in part on the beam adjustment parameter in the transmitted report.

28. The apparatus of claim 27, wherein a beam width of the second beam is based at least in part on a value of the beam adjustment parameter.

29. The apparatus of claim 23, wherein the instructions are further executable by the processor to cause the apparatus to:
receive, from the base station, an indication that the UE is located within the distance threshold for MIMO communications from the base station, wherein receiving the beamformed signal is based at least in part on receiving the indication.

30. An apparatus for wireless communications at a base station, comprising:
a processor;
memory coupled with the processor; and
instructions stored in the memory and executable by the processor to cause the apparatus to:
transmit, to a user equipment (UE), a beamformed signal via a beam within a distance threshold for multiple-input multiple-output (MIMO) communications from the base station; and
receive, from the UE, a report indicating a beam adjustment parameter based at least in part on a signal distribution of the beamformed signal at an antenna panel of the UE.
